(19) United States
(12) Patent Application Publication
(10) Pub. No.: US 2021/0045583 A1
(43) Pub. Date: Feb. 18, 2021

(54) Ice Cream Float Assembly

(71) Applicant: John Mack, Laurel, MD (US)

(72) Inventor: John Mack, Laurel, MD (US)

(21) Appl. No.: 16/541,629

(22) Filed: Aug. 15, 2019

(51) Int. Cl. A47J 43/27; A47G 19/22

(52) U.S. Cl. CPC A47J 43/27; A47G 19/2266

(57) ABSTRACT

An ice cream float assembly includes a first dish that is removably coupled to a beverage bottle thereby facilitating a beverage to be passed therethrough. Ice cream is selectively positioned in the first dish thereby facilitating the beverage to form a mixture with the ice cream. A first coupler is coupled to and extends away from the first dish and the first coupler removably engages the beverage bottle. A second dish is removably coupled to the first dish such that each of the first dish and the second dish form a globe to contain the ice cream. The second dish has a spout extending into an interior of the second dish to pass the mixture of beverage and ice cream therethrough for drinking.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relates to ice cream devices and more particularly pertains to a new ice cream device for mixing soda with ice cream to form an ice cream float.

### BRIEF SUMMARY OF THE INVENTION

An embodiment of the disclosure meets the needs presented above by generally comprising a first dish that is removably coupled to a beverage bottle thereby facilitating a beverage to be passed therethrough. Ice cream is selectively positioned in the first dish thereby facilitating the beverage to form a mixture with the ice cream. A first coupler is coupled to and extends away from the first dish and the first coupler removably engages the beverage bottle. A second dish is removably coupled to the first dish such that each of the first dish and the second dish form a globe to contain the ice cream. The second dish has a spout extending into an interior of the second dish to pass the mixture of beverage and ice cream therethrough for drinking.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of an ice cream float assembly according to an embodiment of the disclosure.

FIG. 2 is a bottom view of an embodiment of the disclosure.

FIG. 3 is an exploded perspective view of an embodiment of the disclosure.

FIG. 4 is a cross sectional view taken along line 4-4 of FIG. 2 of an embodiment of the disclosure.

FIG. 5 is a perspective in-use view of an embodiment of the disclosure.

### DETAILED DESCRIPTION OF THE INVENTION

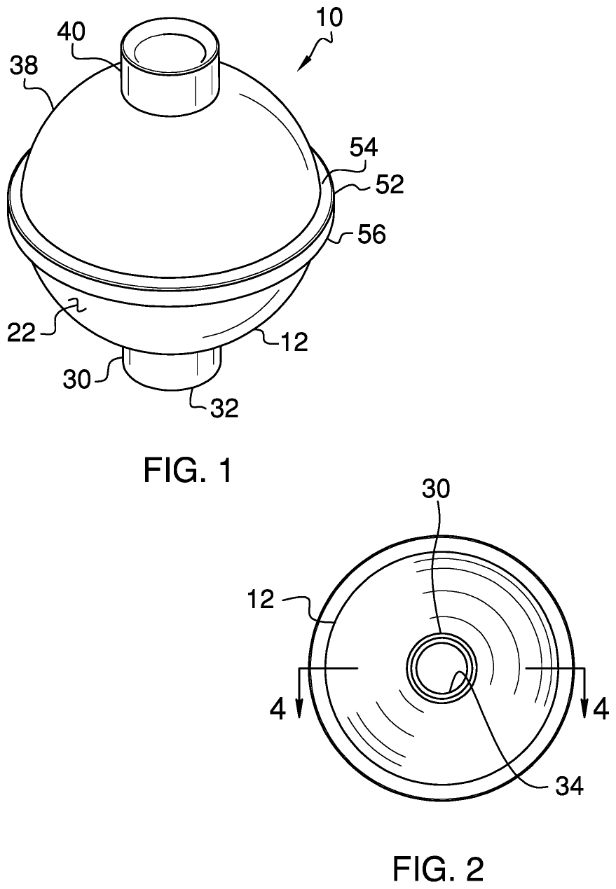

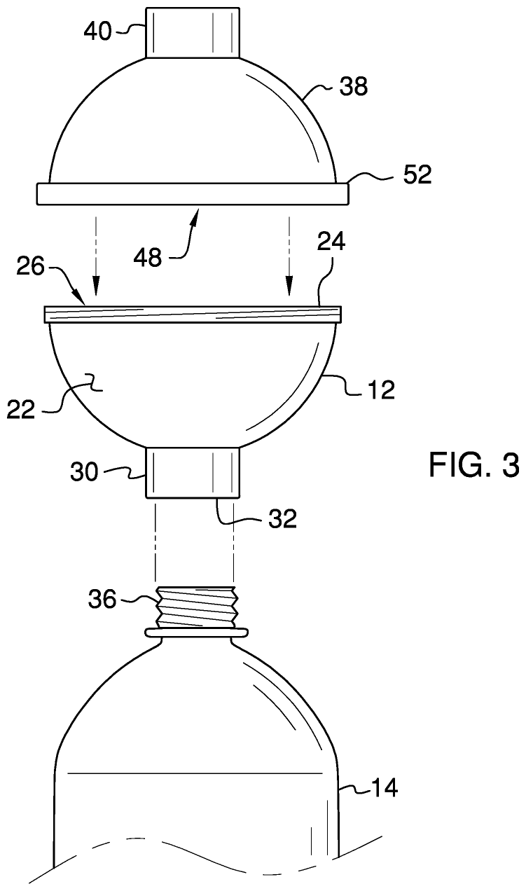

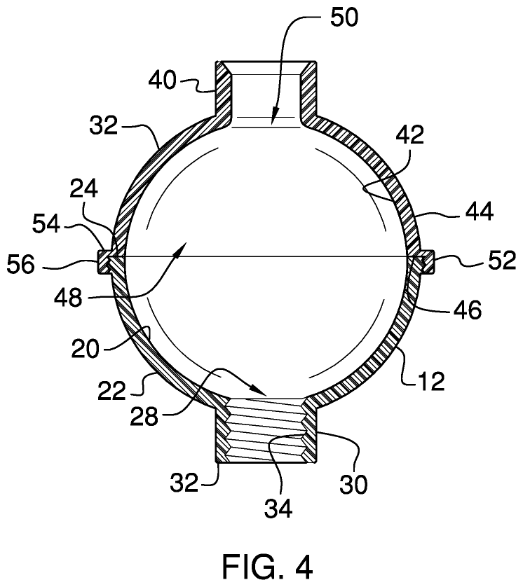

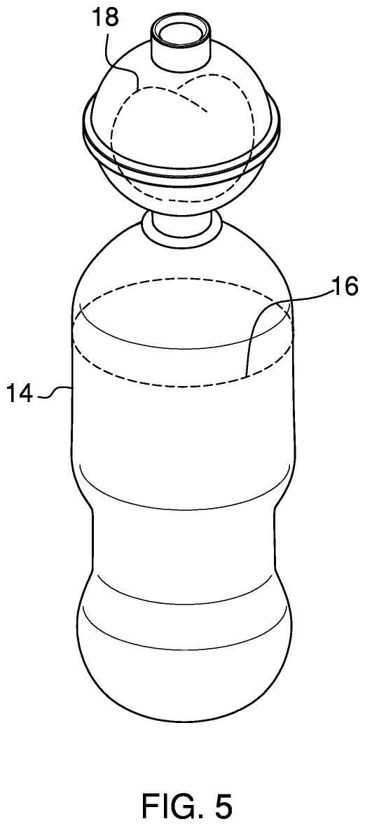

With reference now to the drawings, and in particular to FIGS. 1 through 5 thereof, a new ice cream device embodying the principles and concepts of an embodiment of the disclosure and generally designated by the reference numeral 10 will be described.

As best illustrated in FIGS. 1 through 5, the ice cream float assembly 10 generally comprises a first dish 12 that may be removably coupled to a beverage bottle 14 thereby facilitating a beverage 16 to be passed therethrough. The beverage bottle 14 may be a soda bottle and the beverage 16 may be a carbonated beverage 16 such as soda or the like. Ice cream 18 is selectively positioned therein in the first dish 12 thereby facilitating the beverage 16 to form a mixture with the ice cream 18.

The first dish 12 has an inner surface 20, an outer surface 22 and a top edge 24 extending therebetween. The inner surface 20 is coarcuate with the outer surface 22 such that the first dish 12 has a hemispherical shape. The top edge 24 extends between the inner surface 20 and the outer surface 22 to define a first opening 26 into the first dish 12. Additionally, the first dish 12 has a second opening 28 extending through the inner surface 20 and the outer surface 22. The second opening 28 is positioned opposite the first opening 26 and the outer surface 22 is threaded adjacent to the top edge 24.

A first coupler 30 is coupled to and extends away from the first dish 12 to removably engage the beverage bottle 14. The first coupler 30 has an outer wall 32 and the outer wall 32 is continuous such that the first coupler 30 has a cylindrical shape. The first coupler 30 has a distal end 32 with respect to the first dish 12. The distal end 32 is open and the first coupler 30 is substantially hollow.

The first coupler 30 has an inside surface 34 and the inside surface 34 is threaded. The distal end 32 insertably receives a neck 36 of the beverage bottle 14 thereby facilitating the inside surface 34 to threadeably engage the neck 36. The first coupler 30 is aligned with the second opening 28 in the first dish 12 to pass the beverage 16 into the first dish 12. In this way the beverage 16 mixes with the ice cream 18 to form an ice cream float.

A second dish 38 is provided and the second dish 38 is removably coupled to the first dish 12 such that each of the first dish 12 and the second dish 38 form a globe. The second dish 38 has a spout 40 extending into an interior of the second dish 38 to pass the mixture of beverage 16 and ice cream 18 therethrough for drinking. The second dish 38 has an interior surface 42, an exterior surface 44 and a bottom edge 46 extending therebetween. The interior surface 42 is coarcuate with the exterior surface 44 such that the second dish 38 has a hemispherical shape.

The bottom edge 46 extends between the interior surface 42 and the exterior surface 44 to define a primary opening 48 in the second dish 38. The second dish 38 has a secondary opening 50 extending through the interior surface 42 and the exterior surface 44. The secondary opening 50 is positioned opposite the primary opening 48 and the spout 40 is aligned with the secondary opening 50. In this way the ice cream 18 float is selectively poured through the spout 40 for drinking.

A second coupler 52 is coupled to and second dish 38 and the second coupler 52 threadably engages the first dish 12 to retain the second dish 38 on the first dish 12. The second coupler 52 is positioned on the exterior surface 44 and is aligned with the bottom edge 46. Moreover, the second coupler 52 is continuous such that the second coupler 52 extends around an entire circumference of the second dish 38. The second coupler 52 has a leg 54 and a foot 56. The leg 54 is coupled to and extends outwardly from the exterior surface 44 having the foot 56 extending downwardly from the leg 54. The foot 56 threadably engages the outer surface 22 of the first dish 12 having the bottom edge 46 of the second dish 38 abutting the top edge 24 of the first dish 12.

In use, the first dish 12 is manipulated to facilitate the first coupler 30 to threadably engage the neck 36 of the beverage bottle 14 and the ice cream 18 is positioned in the first dish 12. The second dish 38 is manipulated to facilitate the second coupler 52 to threadably engage the first dish 12. The beverage bottle 14 is tipped from drinking and the beverage 16 in the bottle mixes with the ice cream 18 to form the ice cream float. The ice cream float is poured outwardly from the spout 40 for drinking. Each of the first dish 12 and the second dish 38 are removed from the bottle when the beverage 16 is consumed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An ice cream float assembly being configured to contain ice cream and be removably coupled to a soda bottle, said assembly comprising:
a first dish being configured to be removably coupled to a beverage bottle thereby facilitating a beverage to be passed therethrough, said first dish being configured to have ice cream positioned therein thereby facilitating the beverage to form a mixture with the ice cream;
a first coupler being coupled to and extending away from said first dish wherein said first coupler is configured to removably engage the beverage bottle; and
a second dish being removably coupled to said first dish such that each of said first dish and said second dish form a globe wherein said globe is configured to contain the ice cream, said second dish having a spout extending into an interior of said second dish wherein said spout is configured to pass the mixture of beverage and ice cream therethrough for drinking.

2. The assembly according to claim 1, wherein said first dish has an inner surface, an outer surface and a top edge extending therebetween, said inner surface being coarcuate with said outer surface such that said first dish has a hemispherical shape, said top edge extending between said inner surface and said outer surface to define a first opening into said first dish.

3. The assembly according to claim 2, wherein said first dish has a second opening extending through said inner surface and said outer surface, said second opening being positioned opposite said first opening, said outer surface being threaded adjacent to said top edge.

4. The assembly according to claim 1, wherein said first coupler has an outer wall, said outer wall being continuous such that said first coupler has a cylindrical shape, said first coupler having a distal end with respect to said first dish, said distal end being open, said first coupler being substantially hollow.

5. The assembly according to claim 1, wherein:
said first dish has a second opening; and
said first coupler has an inside surface, said inside surface being threaded, said distal end being configured to insertably receive a neck of the bottle thereby facilitating said inside surface to threadeably engage the neck, said first coupler being aligned with said second opening in said first dish wherein said second opening is configured to pass the beverage into said first dish.

6. The assembly according to claim 1, wherein said second dish has an interior surface, an exterior surface and a bottom edge extending therebetween, said interior surface being coarcuate with said exterior surface such that said second dish has a hemispherical shape, said bottom edge extending between said interior surface and said exterior surface to define a primary opening in said second dish.

7. The assembly according to claim 6, wherein said second dish has a secondary opening extending through said interior surface and said exterior surface, said secondary opening being positioned opposite said primary opening, said spout being aligned with said secondary opening.

8. The assembly according to claim 6, further comprising a second coupler being coupled to and second dish, said second coupler threadably engaging said first dish to retain said second dish on said first dish, said second coupler being positioned on said exterior surface and being aligned with said bottom edge, said second coupler being continuous such that said second coupler extends around an entire circumference of said second dish.

9. The assembly according to claim 8, wherein said second coupler has a leg and a foot, said leg being coupled to and extending outwardly from said exterior surface having said foot extending downwardly from said leg, said foot threadably engaging said outer surface of said first dish.

10. An ice cream float assembly being configured to contain ice cream and be removably coupled to a soda bottle, said assembly comprising:
a first dish being configured to be removably coupled to a beverage bottle thereby facilitating a beverage to be passed therethrough, said first dish being configured to have ice cream positioned therein thereby facilitating the beverage to form a mixture with the ice cream, said first dish having an inner surface, an outer surface and a top edge extending therebetween, said inner surface being coarcuate with said outer surface such that said first dish has a hemispherical shape, said top edge extending between said inner surface and said outer surface to define a first opening into said first dish, said first dish having a second opening extending through said inner surface and said outer surface, said second opening being positioned opposite said first opening, said outer surface being threaded adjacent to said top edge;
a first coupler being coupled to and extending away from said first dish wherein said first coupler is configured to removably engage the beverage bottle, said first coupler having an outer wall, said outer wall being continuous such that said first coupler has a cylindrical shape, said first coupler having a distal end with respect to said first dish, said distal end being open, said first coupler being substantially hollow, said first coupler having an inside surface, said inside surface being threaded, said distal end being configured to insertably receive a neck of the bottle thereby facilitating said inside surface to threadeably engaging the neck, said first coupler being aligned with said second opening in said first dish wherein said second opening is configured to pass the beverage into said first dish;
a second dish being removably coupled to said first dish such that each of said first dish and said second dish form a globe wherein said globe is configured to contain the ice cream, said second dish having a spout extending into an interior of said second dish wherein said spout is configured to pass the mixture of beverage and ice cream therethrough for drinking, said second dish having an interior surface, an exterior surface and a bottom edge extending therebetween, said interior surface being coarcuate with said exterior surface such that said second dish has a hemispherical shape, said bottom edge extending between said interior surface and said exterior surface to define a primary opening in said second dish, said second dish having a secondary opening extending through said interior surface and said exterior surface, said secondary opening being positioned opposite said primary opening, said spout being aligned with said secondary opening; and
a second coupler being coupled to and second dish, said second coupler threadably engaging said first dish to retain said second dish on said first dish, said second coupler being positioned on said exterior surface and being aligned with said bottom edge, said second coupler being continuous such that said second coupler extends around an entire circumference of said second dish, said second coupler having a leg and a foot, said leg being coupled to and extending outwardly from said exterior surface having said foot extending downwardly from said leg, said foot threadably engaging said outer surface of said first dish having said bottom edge abutting said top edge.
